(19) United States
(12) Patent Application Publication
(10) Pub. No.: US 2009/0242367 A1
(43) Pub. Date: Oct. 1, 2009

(54) METHOD OF MONITORING THE POSITION OF A MOVABLE PART OF AN ELECTRICAL SWITCH APPARATUS

(75) Inventors: Marc Bruel, Corenc (FR); Mathias Lamien, Colombe (FR); Sylvain Paineau, Voiron (FR); Fabrice Roudet, Saint-Egreve (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SCHNEIDER ELECTRIC INDUSTRIES SAS, Rueil-Malmaison (FR)

(21) Appl. No.: 12/301,568

(22) PCT Filed: May 14, 2007
(86) PCT No.: PCT/EP2007/054650

§ 371 Date: Nov. 19, 2008

(30) Foreign Application Priority Data
May 19, 2006 (FR) 0651833

(51) Int. Cl. H01H 9/16

(52) U.S. Cl. 200/308

(57) ABSTRACT

A device for monitoring a position of a movable portion mounted on a casing of a switching electrical apparatus, the movable portion configured to adopt at least two determined positions. The device includes a permanent magnet and a reader including an antenna to interchange data without contact by electromagnetic coupling with a receiver element associated with the switching electrical apparatus. The receiver element includes an antenna controlled by a microswitch switched between two states depending on the position of the movable portion to establish or interrupt the electromagnetic coupling between the reader and the receiver element.

The present invention relates to a device for monitoring the position of a movable portion of a switching electrical apparatus. The movable portion is for example the lever of a circuit breaker, for example a mini circuit breaker. The invention also relates to a board that is capable of receiving a plurality of items of switching electrical apparatus such as circuit breakers furnished with a monitoring device of the invention.

Known from U.S. Pat. No. 4,706,073 is a circuit breaker furnished with an alarm circuit actuated in the event of a current overload. A permanent magnet is mounted on the lever of the circuit breaker while a sensor of the Hall effect type is designed to measure the variation of magnetic flux during the change of position of the lever. When there is a trip on an electrical fault, a movement of the permanent magnet causes a variation of magnetic flux sensed by the Hall effect sensor. According to this variation, a detector is capable of generating an output signal representative of an alarm.

In this type of device, the Hall effect sensor may easily be subjected to interference and outside influences when another magnet is brought close to the sensor. The variation of the magnetic flux thus generated may cause inadvertent tripping actions of the alarm when the lever of the circuit breaker is not in the tripped position. In addition, it requires the installation of costly and complex electronic means to measure the variation of the magnetic flux. The installation of several devices of this type in order to detect the state of several circuit breakers present on one and the same electrical circuit board is therefore not very advantageous.

The object of the invention is to propose a device for monitoring the position of a movable portion of a circuit breaker that is very precise, not very sensitive to outside magnetic fields and which may be used in large numbers to monitor in a simple and low-cost manner a plurality of circuit breakers on an electrical circuit board.

This object is achieved by a device for monitoring the position of a movable portion mounted on a casing of a switching electrical apparatus, the said movable portion being able to adopt at least two determined positions, the said device comprising:
a permanent magnet,
a device for detecting the position of the movable portion,

characterized in that
the detection device comprises a reader furnished with an antenna in order to interchange data without contact by electromagnetic coupling with a receiver element associated with the switching electrical apparatus,
the receiver element comprises an antenna controlled by a microswitch switched between two states depending on the position of the movable portion, in order to establish or interrupt the electromagnetic coupling between the reader and the receiver element,
the microswitch is operated by magnetic effect and comprises a movable element that is able to be aligned with the field lines of a magnetic field generated by the permanent magnet.

The device according to the invention is particularly precise because the method of actuating the microswitch requires the presence of the permanent magnet in a determined position. If the permanent magnet is not in a precise position, the microswitch does not switch. The device according to the invention is therefore less prone to interference and does not risk switching inadvertently.

According to a variant embodiment of the invention, the permanent magnet is movable and set in motion by the movable portion and the receiver element is mounted on the casing of the switching electrical apparatus. The permanent magnet is for example supported by the movable portion.

According to the invention, the device comprises a fixed permanent magnet having field lines forcing the movable element to adopt a state. The change of position of the movable portion causes a change of direction of the magnetic field lines created by the said fixed permanent magnet and movable permanent magnet in the vicinity of the movable element, causing it to change state.

According to another variant embodiment of the invention, the permanent magnet is mounted on the casing of the switching electrical apparatus and the receiver element is set in motion by the movable portion. The receiver element is for example supported by the movable portion.

According to another variant embodiment of the invention, the device comprises a movable part forming a mask set in motion by the movable portion and capable of interrupting the magnetic effect produced by the permanent magnet on the microswitch when the movable portion is in one of its at least two positions.

According to the invention, the movable portion of the switching electrical apparatus may adopt three positions, two extreme positions in each of which at least one receiver element is commanded by the permanent magnet to establish or interrupt an electromagnetic coupling with the reader and an intermediate position in which the permanent magnet does not command the receiver element.

According to a particular feature, the microswitch is for example mounted in series with an antenna of the receiver element. In the closed state, the microswitch allows the establishment of the electromagnetic coupling between the reader and the receiver element.

According to another particular feature, the microswitch is for example mounted in parallel relative to an antenna of the receiver element. In the closed state, the microswitch makes it possible to short circuit the antenna and hence interrupt the electromagnetic coupling between the reader and the receiver element.

According to another particular feature, the receiver element is for example an RFID electronic tag positioned on the electrical apparatus. The reader is for example a station for reading this type of tag.

According to another particular feature, the movable portion is for example a pivot-action lever.

According to the invention, the monitoring device may be in the form of an adaptable independent module on a switching electrical apparatus.

The monitoring device is particularly suitable to be used on a switching electrical apparatus such as a circuit breaker and more particularly a mini circuit breaker.

The monitoring device may in particular be applied on each of the circuit breakers of an electrical circuit board. On the electrical circuit board, the reader may for example be common to all the items of switching electrical apparatus present.

Other features and advantages will appear in the following detailed description with reference to an embodiment given as an example and represented by the appended drawings in which:

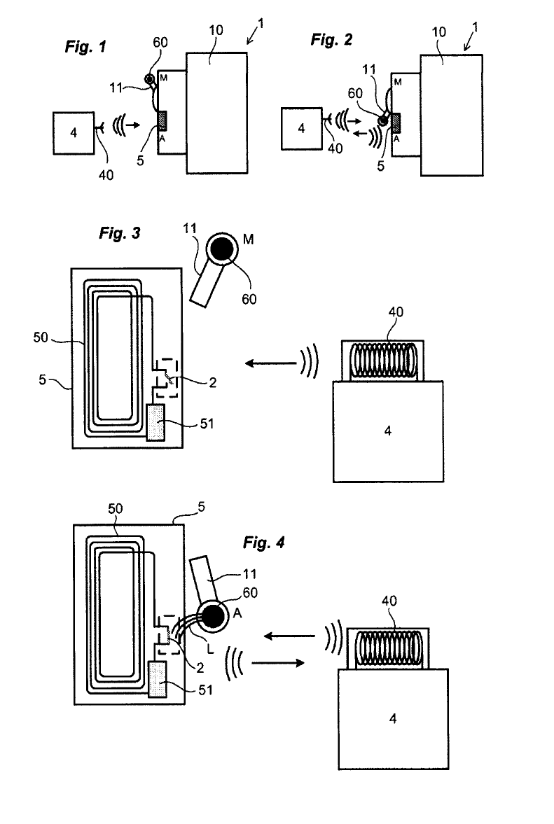

FIGS. 1 and 2 show the monitoring device of the invention applied to a two-position mini circuit breaker.

FIGS. 3 and 4 illustrate schematically the principle of operation of the monitoring device according to the invention.

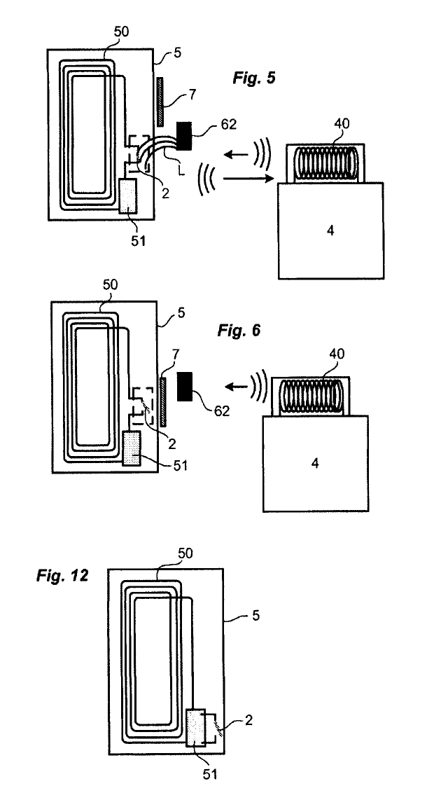

FIGS. 5 and 6 illustrate schematically a variant embodiment of the monitoring device according to the invention.

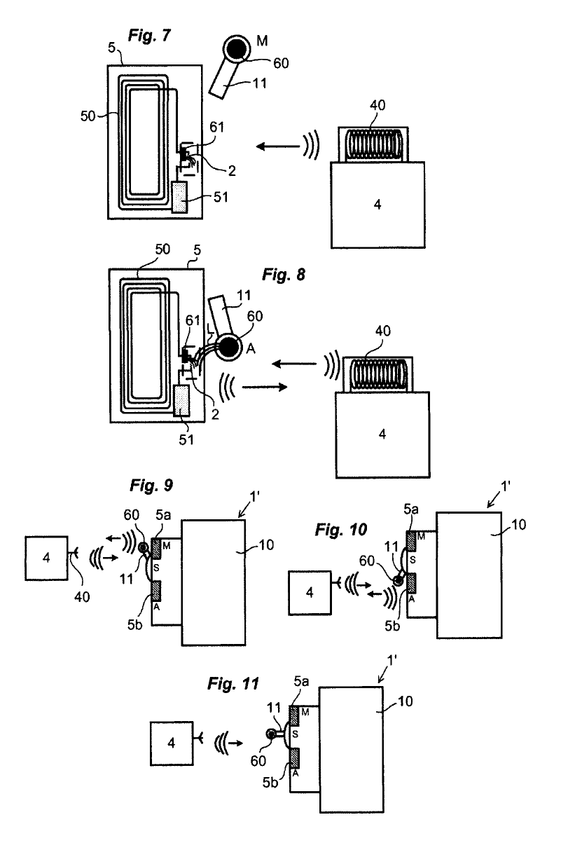

FIGS. 7 and 8 represent schematically another variant embodiment of the monitoring device of the invention.

FIGS. 9 to 11 show a variant of the monitoring device according to the invention applied to a three-position circuit breaker.

FIG. 12 represents a variant embodiment of the receiver element according to the invention.

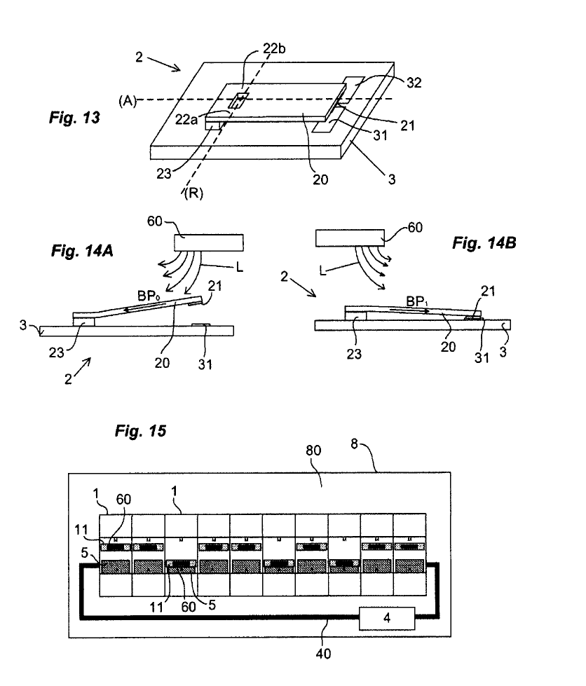

FIG. 13 represents a microswitch such as that used in the monitoring device of the invention.

FIGS. 14A and 14B represent the microswitch of FIG. 13 respectively in the open position and in the closed position, actuated by a permanent magnet.

FIG. 15 represents an electrical circuit board comprising an array of mini circuit breakers furnished with the monitoring device according to the invention.

The device according to the invention is applied to monitor the position of the movable portion of a switching electrical apparatus.

The switching electrical apparatus is more particularly an apparatus of disconnection such as for example a switch, a fuse-holder or a circuit breaker 1, more particularly a mini circuit breaker. In a known manner, a circuit breaker 1 comprises a casing 10 on which is mounted the movable portion consisting of a pivoting or rotary lever 11. The lever 11 may be set in motion between at least two positions, an ON (M) position and an OFF (A) position. The movement between the two positions ON (M) and OFF (A) may be carried out in an intentional manner by a user or in an automatic manner when an electrical fault such as a short circuit is detected. Certain circuit breakers 1′ may be provided with three positions, with an intermediate position (S) of the lever situated half-way between the ON (M) position and the OFF (A) position in order to signal the electrical fault or indicate the fusing of the contacts (FIGS. 9 to 11).

In FIGS. 1 to 8, the circuit breaker 1 represented has two positions.

The monitoring device according to the invention comprises a reader consisting of a station 4 for transmitting/receiving electromagnetic waves. In a known manner, such a station 4 comprises an antenna 40 suitable for transmitting/receiving electromagnetic waves in a determined zone of action. Such a station 4 also comprises a radio frequency transmit/receive device transmitting, at a determined carrier frequency, an electronic processor unit and a memory associated with the processor unit. For reasons of simplification, these known elements are not represented in the figures.

The device according to the invention also comprises a receiver element 5 such as an electronic tag comprising its own antenna 50. Such a tag also comprises a radio frequency transmit/receive device, and an electronic processor unit and a memory for storing information on an electronic chip 51. Depending on its type, active or passive, the tag may also comprise its own power source.

In a known manner, an antenna 40, 50 is formed by an inductor optionally associated with a resistor and a capacitor in order to match the impedance of the antenna and tune the desired carrier frequency. The antenna of the receiver element may be of the dipole type or consist of a coil of copper wire (FIGS. 3 to 8). The antenna 40 of the station 4 may be integrated inside the station 4 or be separate from the station 4 by being connected to the casing of the station 4 via an electric cable. The antenna 50 of the receiver element 5 is incorporated inside the tag. In FIGS. 3 to 8, the receiver element 5 is represented with an antenna 50 consisting of a coil of copper wire. However, the invention must be understood as if the antenna 50 can be of any other known type.

The device of the invention operates according to the RFID technology. In the RFID technology, when an electronic tag such as the receiver element 5 is in the field of action of the station 4 and the station 4 transmits an electromagnetic signal, there is electromagnetic coupling between the tag and the station 5, the antenna 40 of the station 4 and the antenna 50 of the tag being able to be considered to be the primary and the secondary of a transformer. The electronic tag is supplied by the “carrier” transmitted from the antenna 40 of the station 4 as soon as it arrives within the limits of range of the said station 4. The energy captured by the antenna 50 of the tag is transformed into electric energy and supplies the internal electronic circuits mounted on the chip 51 of the tag. The tag responds to the signal transmitted by the station 4 and a dialogue may be established, the information being interchanged by amplitude or phase modulation on the carrier frequency. Each tag usually stores a unique identifier which it transmits to the station 4 in order to allow it to be recognized by the station 4.

The value of the frequency of the transmission carrier may be chosen in a zone called low frequencies (for example 125 KHz) or preferably high frequencies (for example 13.56 MHz) or even Ultra High Frequencies (900 MHz and 2.45 GHz). In these two cases, the system operates in inductive coupling in a near field, that is to say usually with a range of the order of from a few centimetres to a few tens of centimetres depending on the available energy.

According to the invention, with reference to FIGS. 1 and 2, the receiver element 5 is mounted on the casing 10 of the circuit breaker 1, opposite the lever 11 when the latter is in one of its positions, for example in the OFF (A) position. The receiver element 5 is positioned within the range of the antenna 40 of the station 4 which transmits permanently or at regular intervals an electromagnetic system to the receiver element 5. The station 4 and the receiver element 5 are perfectly fixed relative to the circuit breaker 1. The station 4 may for example be integrated into the electrical circuit board designed to support one or more circuit breakers 1.

According to the invention, the receiver element 5 is commanded by a microswitch 2 mounted in series (FIGS. 3 to 8) or in parallel (FIG. 12) relative to its antenna 50. This microswitch 2 may be switched by an actuator between two states, an open state (FIG. 3) and a closed state (FIG. 4). Depending on its state, the microswitch 2 makes it possible to establish or interrupt the electromagnetic coupling between the receiver element 5 and the station 4.

According to the invention, the microswitch 2 is controlled by magnetic effect. It is for example a microswitch 2 sensitive to the orientation of the field lines L of a magnetic field generated by a magnetic actuator. This type of microswitch is for example manufactured in MEMS (for Micro-Electro-Mechanical System) technology.

An exemplary configuration of a microswitch 2 sensitive to the orientation of the field lines L is represented in FIGS. 13 to 14B.

A microswitch 2 sensitive to the orientation of the field lines L comprises a deformable ferromagnetic movable membrane 20 able to be actuated in rotation about an axis of rotation (R) by the magnetic actuator. The membrane 20 is for example Iron-Nickel.

The membrane 20 has a longitudinal axis (A) and is connected, at one of its ends, by means of connecting arms 22a, 22b, to one or more anchor blocks 23 secured to a substrate 3. The substrate 3 is for example that on which the electronic chip 51 of the receiver element 5 is mounted. The membrane 20 is capable of pivoting relative to the substrate 3 along its axis (R) of rotation perpendicular to its longitudinal axis (A). The connecting arms 22a, 22b form an elastic connection between the membrane 20 and the anchor block 23 and are made to bend when the membrane 20 pivots.

At its distal end relative to its axis of rotation, the membrane supports a movable contact 21. By pivoting, the membrane 20 may adopt at least two determined states, an open state (FIG. 14A) in which two fixed electric tracks 31, 32 deposited on the substrate 3 are disconnected, or a closed state (FIG. 14B) in which the two tracks 31, 32 are connected together by the movable contact 21 supported by the membrane 20 so as to close the branch of the circuit situated in series or in parallel relative to the antenna 50 of the receiver element 5.

One of the methods of actuating the membrane 20 consists in applying a magnetic field created by a permanent magnet 60. The ferromagnetic membrane 20 moves between its two states while aligning itself on the field lines L of the magnetic field generated by the permanent magnet 60. With reference to FIGS. 14A and 14B, the magnetic field of the permanent magnet 60 has field lines L whose orientation generates a magnetic component BP₀, BP₁ in a ferromagnetic layer of the membrane 20 along its longitudinal axis (A). This magnetic component BP₀, BP₁ generated in the membrane 20 causes a magnetic torque forcing the membrane 20 to adopt one of its states, closed (FIG. 14B) or open (FIG. 14A). By moving the permanent magnet 60 relative to the membrane 20, it is therefore possible to subject the membrane to two different orientations of the field lines L of the magnetic field of the permanent magnet 60 and to cause the membrane 20 to switch between its two states.

According to the invention, the permanent magnet 60 moves at the same time as the lever 11. The permanent magnet 60 is, for example, mounted directly on the lever 11 of the circuit breaker 1 or, according to a variant, it may also be simply fixed mechanically to the lever, by, for example, being mounted on a movable part actuated in vertical translation each time the lever 11 moves. Depending on the position of the lever 11, the membrane 20 of the microswitch 2 is either under the magnetic influence of the permanent movable magnet 60 or not. When the lever 11 is in the ON (M) position (FIG. 3), the microswitch 2 is not under the influence of the magnetic field generated by the permanent magnet 60. The membrane 20 is therefore in a rest position, parallel to the substrate (FIG. 13). When the lever 11 is placed automatically or intentionally in the OFF (A) position (FIG. 4), the permanent magnet 60 supported by the lever 11 has magnetic field lines L whose direction forces the membrane 20 to move to its closed state (FIG. 14B). Therefore, if the microswitch 2 is placed in series relative to the antenna 50 of the receiver element 5, it establishes an electromagnetic coupling between the receiver element 5 and the station 4 or if it is placed in parallel relative to the antenna 50 of the receiver element 5, it interrupts this electromagnetic coupling between the receiver element 5 and the station 4. When the lever 11 is returned to the ON (M) position, the microswitch 2 is no longer under the influence of the magnetic field of the permanent magnet 60, which, by mechanical effect, causes the membrane 20 to return to the rest position and therefore causes the interruption of the electromagnetic coupling or the reestablishment of this coupling, depending on the mounting of the microswitch 2 relative to the antenna 50 of the receiver element 5.

According to a variant embodiment not shown, the arrangement between the permanent magnet 60 and the receiver element 5 may be inverted, the receiver element 5 becoming movable, mechanically secured to the lever 11 and the permanent magnet 60 becoming fixed. The movement of the lever 11 brings the receiver element 5 opposite the permanent magnet 60, causing the switching of the microswitch 2 under the influence of the magnetic field created by the permanent magnet 60. The operation of this variant embodiment is identical to that described just above.

According to a variant embodiment shown in FIGS. 7 and 8, the microswitch 2 is for example permanently subjected to the magnetic field of a second fixed permanent magnet 61. This fixed permanent magnet 61 is positioned relative to the microswitch 2 so that the direction of its field lines forces the membrane 20 to be in the open state or the closed state, establishing or interrupting the electromagnetic coupling between the station 4 and the receiver element 5 depending on the mounting of the microswitch 2 relative to the antenna 50 of the receiver element 5. For example, when the lever 11 is in the ON (M) position, under the sole influence of the magnetic field generated by the fixed permanent magnet 61, the membrane 20 is in the open state or in the closed state depending on the direction of the field lines of the magnetic field generated by the fixed permanent magnet 61. The change of position of the lever 11 and hence of the movable permanent magnet 60, from the ON (M) position to the OFF (A) position, causes a change of direction of the magnetic field lines created jointly by the movable permanent magnet 60 and the fixed permanent magnet 61 and seen by the membrane 20. The new direction of the field lines L seen by the membrane 20 forces it to move into its other state, closed or open. In this variant embodiment, in each of its states, the membrane 20 is therefore commanded by magnetic effect irrespective of the position of the lever 11 of the circuit breaker 1.

According to another variant embodiment represented in FIGS. 5 and 6, a single fixed permanent magnet 62 is positioned opposite the receiver element 5 in order to act permanently on the microswitch 2 of the receiver element 5. This fixed permanent magnet 62 is for example mounted on the casing 10 of the circuit breaker 1 (not visible in FIGS. 5 and 6). The lever 11 (for reasons of simplification not shown in FIGS. 5 and 6) is capable of moving a movable part 7 made of a magnetic material. This movable part 7 is secured to the lever 11 and constitutes a mask which is capable, depending on the position of the lever 11, of interposing itself between the permanent magnet 62 and the receiver element 5 in order to interrupt the magnetic effect of the permanent magnet 62 on the microswitch 2 and therefore, depending on whether the microswitch 2 is mounted in parallel or in series relative to the antenna 50 of the receiver element 5, of establishing or interrupting the electromagnetic coupling between the station 4 and the receiver element 5.

The principle of operation of the invention described above with reference to FIGS. 1 to 4 may also be adapted for circuit breakers 1′ (FIGS. 9 to 11) whose lever 11 may take three determined positions, an ON (M) position, an OFF (A) position and an intermediate position (S) situated half-way between the ON (M) position and the OFF (A) position, this intermediate position (S) making it possible to indicate an electrical fault or a fusing between the contacts. This three-position circuit breaker 1′ is identical externally to the two-position circuit breaker 1 described above. On this three-position circuit breaker 1′, two receiver elements 5a, 5b are positioned on the casing 10, one opposite the lever 11 when the latter is in the ON (M) position and the other opposite the lever 11 when the latter is in the OFF (A) position. These receiver elements 5a, 5b are identical to the receiver element 5 described above and may be actuated according to one of the variant embodiments described above. They may in particular be actuated directly by a movable permanent magnet 60 secured to the lever 11 as in FIGS. 1 to 4, or each associated with a fixed permanent magnet 61 mounted on the casing 10 and actuated by a movable permanent magnet 60 secured to the lever as in FIGS. 7 and 8. The principle of operation of this variant embodiment is described below with an actuation with a movable permanent magnet 60 secured to the lever 11 and with microswitches 2 mounted in series with the antenna 50 of their receiver element 5a, 5b.

According to this variant embodiment, in normal operation, whether the lever 11 is in the ON (M) position or in the OFF (A) position, the station 4 always receives a signal from one of the receiver elements 5a, 5b by electromagnetic coupling (FIGS. 9 and 10). The receiver elements 5a, 5b store a different identifier in order to be able to be distinguished by the station 4. In the event of an electrical fault or fusing between the contacts, the lever 11 is in the intermediate position (S) (FIG. 11). According to this variant, the receiver elements 5a, 5b and/or the permanent magnet 60 are arranged in such a way that, in this position of the lever 11, the magnetic field created by the permanent magnet 60 has no influence on each of the microswitches 2 of the two receiver elements 5a, 5b. Therefore, in this position of the lever 11, the receiver elements 5a, 5b transmit no signal in the direction of the station 4, which may then report the presence of an electrical fault or of a fusing of the contacts.

On each of the two receiver elements 5a, 5b, the microswitch 2 is mounted in series with the antenna 50 but mounting in parallel may be envisaged. However, in this latter case, the station 4 receives no signal when the lever 11 is in the ON or OFF position and receives a signal from both receiver elements 5a, 5b when the lever 11 is in the intermediate position.

Instead of two receiver elements 5a, 5b and one permanent magnet 60, a single receiver element secured to the lever and two permanent magnets each mounted on the casing 10 opposite both of the two positions, ON and OFF, of the lever 11 may be employed. However, in this configuration, one and the same signal will be sent to the station 4 whether the lever 11 is in the ON or OFF position. By mounting the microswitch 2 in parallel relative to the antenna 50 of the receiver element, only one signal may be sent to the station when the lever 11 is in the intermediate position (S).

The monitoring device described above may be applied in each circuit breaker 1 of an electrical circuit board 8 comprising a plurality of circuit breakers 1. In this board 8 shown in FIG. 15, the station 4 may be common to all the circuit breakers 1 in order to read all the receiver elements 5 of all the circuit breakers 1 of the board. On the electrical circuit board 8, the circuit breakers are covered by a shield 80 on which, for example, the antenna 40 of the station 4 is placed.

This board 8 comprises for example one or more rows of circuit breakers 1 each furnished with a lever 11 whose position is monitored thanks to a monitoring device according to the invention. Since a unique identifier is assigned to each receiver element 5 of a circuit breaker 1, the station 4 is capable, based on a processing means optionally using anticollision methods, of knowing the state of each lever 11 of the circuit breakers 1 mounted on the board 8. The processing means may be coupled to signalling members consisting of LEDs designed to indicate the state of each circuit breaker 1 of the board.

According to the invention, each receiver element 5 may also store information relating to the circuit breaker 1 with which it is associated, such as for example the name of the electric circuit that it is responsible for commanding.

Each receiver element 5 may be accessible in read mode and optionally in write mode.

The monitoring device according to the invention is particularly easy to put in place and does not require fundamentally converting the switching electrical apparatus, which makes it possible to restrict the cost of its installation.

It is clearly understood that it is possible, without departing from the context of the invention, to imagine other variants and enhancements of detail and even to envisage the use of equivalent means.

1-15. (canceled)

16. A device for monitoring a position of a movable portion mounted on a casing of a switching electrical apparatus, the movable portion configured to adopt at least two determined positions, the device comprising:
a permanent magnet;
a detection device that detects the position of the movable portion;
the detection device comprising a reader including an antenna to interchange data without contact by electromagnetic coupling with a receiver element associated with the switching electrical apparatus,
the receiver element comprising an antenna controlled by a microswitch switched between two states depending on the position of the movable portion, to establish or interrupt the electromagnetic coupling between the reader and the receiver element,
wherein the microswitch is operated by magnetic effect and comprises a movable element that is configured to be aligned with the field lines of a magnetic field generated by the permanent magnet.

17. A device according to claim 16, wherein the permanent magnet is movable and set in motion by the movable portion and the receiver element is mounted on the casing of the switching electrical apparatus.

18. A device according to claim 17, wherein the permanent magnet is supported by the movable portion.

19. A device according to claim 17, further comprising a fixed permanent magnet having field lines forcing the movable element to adopt a state, and wherein a change of position of the movable portion causes a change of direction of the magnetic field lines created by the fixed permanent magnet and movable permanent magnet in the vicinity of the movable element, causing the movable element to change state.

20. A device according to claim 16, wherein the permanent magnet is mounted on the casing of the switching electrical apparatus and the receiver element is set in motion by the movable portion.

21. A device according to claim 20, wherein the receiver element is supported by the movable portion.

22. A device according to claim 16, further comprising a movable part forming a mask set in motion by the movable portion and configured to interrupt the magnetic effect produced by the permanent magnet on the microswitch when the movable portion is in one of its at least two positions.

23. A device according to claims 16, wherein the movable portion of the switching electrical apparatus may adopt three positions, two extreme positions in each of which at least one receiver element is commanded by the permanent magnet to establish or interrupt an electromagnetic coupling with the reader and an intermediate position in which the permanent magnet does not command the receiver element.

24. A device according to claim 16, wherein the microswitch is mounted in series with an antenna of the receiver element.

25. A device according to claims 16, wherein the microswitch is mounted in parallel relative to an antenna of the receiver element.

26. A device according to claims 16, wherein the receiver element includes an RFID electronic tag positioned on the electrical apparatus.

27. A device according claim 16, wherein the movable portion includes a pivot-action lever.

28. A switching electrical apparatus comprising a monitoring device according to claim 16.

29. An apparatus according to claim 28, comprising a mini circuit breaker.

30. An electrical circuit board configured to receive a plurality of items of switching electrical apparatus of the type defined in claim 28, wherein the reader is common to the plurality of items of switching electrical apparatus.
